(19) United States
(12) Patent Application Publication
(10) Pub. No.: US 2017/0374447 A1
(43) Pub. Date: Dec. 28, 2017

(54) EARBUDS FOR USE BOTH WIRELESSLY AND WITH A WIRED CONNECTION

(71) Applicant: David Baum, Orem, UT (US)

(72) Inventor: David Baum, Orem, UT (US)

(21) Appl. No.: 15/399,513

(22) Filed: Jan. 5, 2017

Related U.S. Application Data
(60) Provisional application No. 62/353,453, filed on Jun. 22, 2016.

(51) Int. Cl. H04R 1/10; H04R 1/02

(52) U.S. Cl. CPC H04R 1/1025; H04R 1/1033; H04R 2420/07; H04R 1/023; H04R 1/1016; H04R 2420/09

(57) ABSTRACT

An earbud for producing a sound output based on an audio signal that is received via a wired connection or wirelessly. The earbud includes a speaker configured to produce a sound based on an audio signal and a battery, wherein the battery is configured to provide power to the speaker. The earbud also includes an antenna, wherein the antenna is configured to connect wirelessly to an external device. The earbud further includes a connector, the connector configured to receive power to charge the battery and connect to the external device. The audio signal is received either over the connector or the antenna. The earbud additionally includes a processor configured to control the electrical elements of the earbud.

### CROSS-REFERENCE TO RELATED APPLICATIONS

This application claims the benefit of and priority to U.S. Provisional Patent Application Ser. No. 62/353,453 filed on Jun. 22, 2016, which application is incorporated herein by reference in its entirety.

### BACKGROUND OF THE INVENTION

Wireless earbuds suffer from a number of drawbacks. For example, the music can occasionally slip out of sync between the two earphones and the he volume level drifted out of balance as well. Further, the touch commands—which allow you to control playback functions with the tap of a finger—may be inconsistent. For example, the earbuds may not respond or may malfunction (e.g., quickly cycling among play, pause, and rewind unprompted).

In addition, the earbuds can be easy to misplace. In particular, during vigorous exercise, the earbuds can shake loose and if they fall from a user's ear during activity, they can be virtually impossible to locate.

However, users are expected to adopt this technology because of the benefits offered by wireless earbuds. In particular, users have a much broader range of motion available and user's need not have the electronic device carried by the user (for example, the electronic device can be in a pack or located in the vicinity of the user). In addition, cords can sometimes be a hindrance or otherwise be inconvenient for a user.

Accordingly, there is a need in the art for earbuds that can be used both wirelessly and with a wired connection.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an earbud for producing a sound output based on an audio signal that is received via a wired connection or wirelessly. The earbud includes a speaker configured to produce a sound based on an audio signal and a battery, wherein the battery is configured to provide power to the speaker. The earbud also includes an antenna, wherein the antenna is configured to connect wirelessly to an external device. The earbud further includes a connector, the connector configured to receive power to charge the battery and connect to the external device. The audio signal is received either over the connector or the antenna. The earbud additionally includes a processor configured to control the electrical elements of the earbud.

Another example embodiment includes an earbud for producing a sound output based on an audio signal that is received via a wired connection or wirelessly. The earbud includes a speaker, wherein the speaker produces a sound based on an audio signal and a battery, wherein the battery provides power to the speaker. The earbud also includes a user input, wherein the user input receives one or more commands from a user an antenna, wherein the antenna connects wirelessly to an external device. The earbud further includes a connector, the connector receiving power to charge the battery and connected to the external device. The audio signal is received either over the connector or the antenna. The earbud additionally includes a processor, wherein the processor controls at least some of the electrical elements of the earbud.

Another example embodiment includes an earbud for producing a sound output based on an audio signal that is received via a wired connection or wirelessly. The earbud includes an audio cone, the audio cone shaped to fit the ear canal of a user and a tip covering the audio cone. The earbud also includes a speaker within the audio cone, wherein the speaker produces a sound based on an audio signal and a battery, wherein the battery provides power to the speaker. The earbud further includes a user input, wherein the user input receives one or more commands from a user and an antenna, wherein the antenna connects wirelessly to an external device. The earbud additionally includes a connector, the connector receiving power to charge the battery and connected to the external device. The audio signal is received either over the connector or the antenna. The earbud moreover includes a cable, wherein the cable includes a coupler that is electrically connected to the connector and is connected to the connector and the external device. The earbud also includes a processor, wherein the processor controls at least some of the electrical elements of the earbud.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram of an earbud;

FIG. 2 illustrates an example of an earbud;

FIG. 3 illustrates an example of a cable;

FIG. 4 illustrates an example of an earbud connected to a cable;

FIG. 5 illustrates an example of a converter for connecting an external device to the earbud via a cable; and

FIG. 6 illustrates an example of a charging case.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

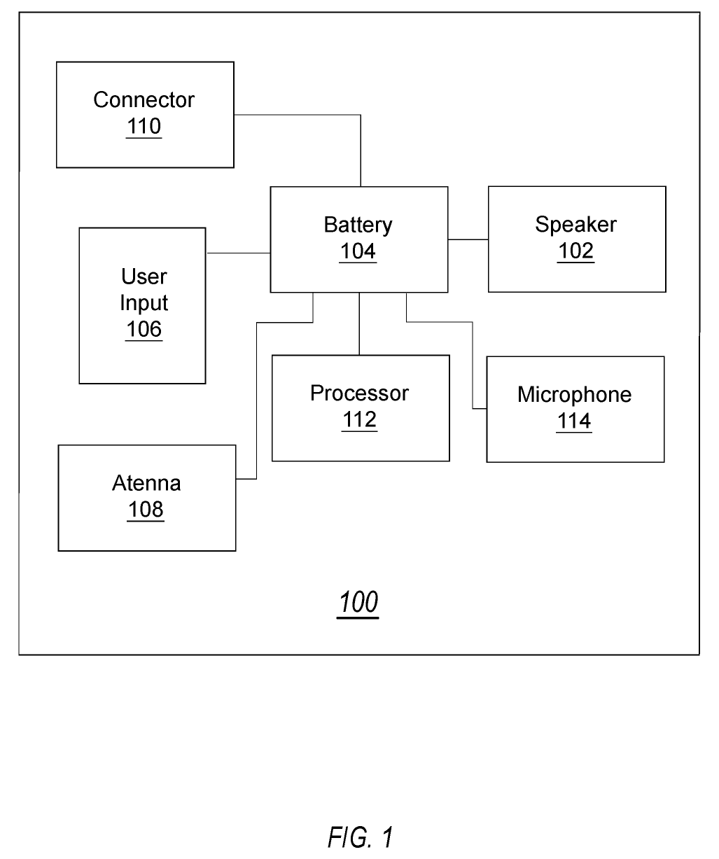

FIG. 1 is a block diagram of an earbud 100. The earbud 100 is small enough that a portion of the earbud 100 can be placed in the ear of a user. The earbud 100 can allow a user to either connect to a device wirelessly or via a wired connection, as described below. The earbud 100 is also known as headphones, earspeakers, earphones, or cans.

FIG. 1 shows that the earbud 100 can include a speaker 102. The speaker 102 can include an electroacoustic transducer, which converts an electrical signal to a corresponding sound. The speaker 102 can be small enough that the sound produced is produced in the user's ear canal and is heard only by the user. The speaker 102 can include a port which allows the sound to exit the earbud 100 and enter the ear canal of the user. One of skill in the art will appreciate that the speaker 102 can include a grill or other mechanism for protecting the transducer of the speaker 102.

FIG. 1 also shows that earbud 100 can include a battery 104. The battery 104 provides electrical power to the other components of the earbud 100. The battery 104 can convert electrical energy to chemical energy and vice versa. The battery 104 can include charging circuitry which allows a user to recharge the battery 104 as needed. The battery 104 is capable of powering components of the earbud 100 even when being charged. Thus, the battery 104 can allow a user to use the earbud 100 in both a wireless mode and in a wired mode, as described below.

FIG. 1 further shows that the earbud 100 can include a user input 106. The user input 106 can include one or more buttons or other devices which allows a user to control the operation of the earbud 100. For example, the user input 106 can allow a user to turn on the earbud 100, adjust the volume, change modes, connect to an external device, or any other desired function. The user input 106 can include any mechanism for user control. E.g., the user input 106 can include slide switches, depressible buttons, dials, wheels, navigation pads, touch pads, or any other desired mechanism.

FIG. 1 additionally shows that the earbud 100 can include an antenna 108. The antenna 108 allows the earbud 100 to wirelessly connect to an external device. The external device provides a signal that is routed from the antenna 108 to the speaker 102 allowing the user to hear audio. For example, the antenna 108 can communicate via Bluetooth, Home RF, iEEE 802.11 or any other desired wireless protocol. In addition, the antenna 108 can include an amplifier. The amplifier increases the strength of the signal to drive the speaker 102 with sufficient power to create an audio signal that can be heard by the user. One of skill in the art will appreciate that the antenna 108 can allow the user to give commands to the earbud 100. I.e., instead of a user input 106, the external device can control the earbud 100 via antenna 108.

FIG. 1 moreover shows that the earbud 100 can include a connector 110. The connector 110 allows the earbud 100 to be connected to an external device. For example, the connector 110 can allow the earbud 100 to be connected to a charging device, such as a charging case or wired connection, as described below. Additionally or alternatively, the connector 110 can allow the earbud 100 to be connected to a data and/or power cord, as described below. The connector 110 can be connected to the battery 104 allowing the batter to be recharged when desired.

FIG. 1 also shows that the earbud 100 can include a processor 112. The processor 112 controls the functions of the earbud 100. In particular, the processor 112 can be electrically coupled to the other components through circuit boards (such as printed circuit boards) and/or wires. Additionally or alternatively, the processor 112 may facilitate wireless communications with a host device by generating signals for wireless transmission and process received wireless signals. In addition to wireless communications, processor 112 may coordinate the operation of the various components of earbud 100. For example, processor 112 may control the charging of a battery or the operation of a display system.

FIG. 1 further shows that the earbud 100 can include a microphone 114. A microphone 114, colloquially nicknamed mic or mike is a transducer that converts sound into an electrical signal. The microphone 114 can allow a user to speak (e.g., as part of a phone conversation or to give a voice command) and/or can be used for noise cancellation purposes. The microphone 114 can include any desired type of transducer, including a dynamic transducer, a condenser transducer, a piezoelectric transducer, or any other desired mechanism. The microphone 114 can include a preamplifier (an electronic amplifier that prepares a small electrical signal for further amplification or processing) that allows the signal to be transmitted to the connected external device.

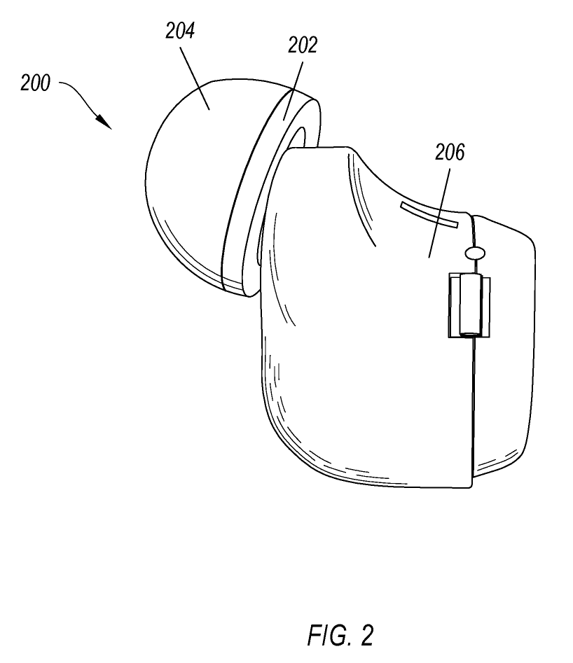

FIG. 2 illustrates an example of an earbud 200. The earbud 200 can include some or all of the components of the earbud 100 of FIG. 1. The earbud 200 can be used in isolation, with another earbud in the opposite ear of the same user (e.g., to produce stereo sound) or in combination with other headphone sets to allow multiple users to share audio.

FIG. 2 shows that the earbud 200 can include an audio cone 202. The audio cone 202 is configured to be placed within the ear canal of the user and direct the sound from the speaker to the user's ear canal. I.e., the audio cone 202 is the portion of the earbud 202 where sound is produced and sent to the user's ear. The audio cone can include a screen or other cover that protects the speaker. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 2 also shows that the earbud 200 can include a tip 204. The tip 204 covers the audio cone 202 and secures the audio cone 202 within the ear canal. The tip 204 is made of an elastic material that conforms to the ear canal of the user. For example, the tip 204 can be made of memory foam, rubber or any other desired material. When the user inserts the audio cone 202 and into his/her ear, the tip 204 deforms and then expands to fill the user's ear canal. This retains the audio cone 202 within the ear canal, helps contain the sound produced in the speaker within the user's ear canal and prevents some external noise from entering the user's ear canal.

FIG. 2 further shows that the earbud 200 can include a body 206. The body 206 contains one or more components of the earbud 200. For example, the body 206 can surround the antenna, processor, etc. of the earbud 200. Additionally or alternatively, the body 206 can include one or more shielding elements. For example, the body 206 can include a divider that shields electric current providing power to the battery from the antenna to prevent the introduction of noise into an audio signal. In addition, the body 206 can be shaped to be aesthetically pleasing to the user.

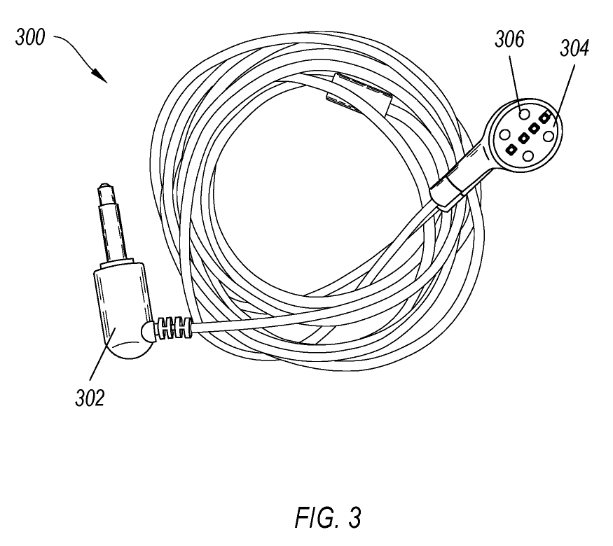

FIG. 3 illustrates an example of a cable 300. The cable 300 connects to the earbud 100 of FIG. 1. The cable 300 allows for simultaneous charging and listening by a user. E.g., if the battery in the earbud 100 of FIG. 1 has insufficient charge to power the earbud 100, then the cable 300 can be connected and simultaneously the earbuds powered, the battery charged, and an audio signal received via the connection of the cable 300. Likewise, a power source, such as a battery pack, can be connected to the earbud via cable 300 for charging purposes while the earbud is connected wirelessly to an external device.

FIG. 3 shows that the cable 300 can include a jack 302. The jack 302 allows for power and/or data to flow through the cable 300. For example, the jack 302 can include a 3.5 mm audio jack. An audio jack (also called “phone connector,” “phone jack,” “headphone jack” or “jack plug”) is an electrical connector. An audio jack is cylindrical in shape and can include two, three, four or five contacts made of conducting material separated by narrow bands of insulating material. One contact provides a ground and the remaining contacts are positive terminals over which signals are sent. Because the signal is transmitted via a voltage difference relative to the ground, the voltage can also be used to power the speaker and charge the battery. One of skill in the art will appreciate that one contact can be dedicated to providing power to the battery if so desired (i.e., the “signal” can just be a constant voltage used to provide power to charge the battery).

FIG. 3 also shows that the cable 300 can include a coupler 304. The coupler 304 connects to the connector of an earbud. The coupler 304 allows one or more signals (including a possible power signal) to pass to the earbud. That is, the coupler 304 includes electrical contacts that match the electrical contacts on an earbud, allowing electrical signals to be passed from the electronic device via contacts on the jack 304 to the earbud. The electrical contacts of the coupler 304 are separated by one or more insulating sections to prevent shorting of the electrical contacts.

FIG. 3 further shows that the cable 300 can include an aligning feature 306. The aligning feature 306 ensures that the electrical contacts of the coupler 304 is properly aligned with the connector of the earbud. For example, the aligning feature can include a protrusion, an indentation, a magnet or any other mechanism that ensures that the coupler 304 and the connector are aligned relative to one another. One of skill in the art will appreciate that the aligning feature 306 may vary for connection to the left earbud and the right earbud. I.e., the aligning feature 306 can also ensure that only a left earbud is connected to the left coupler 304 and only a right earbud is connected to the right coupler 304. Alternatively, there may be no difference with either earbud capable of connecting to either coupler 304 (i.e., the coupler may detect which earbud is connected or which earbud is connected may be irrelevant).

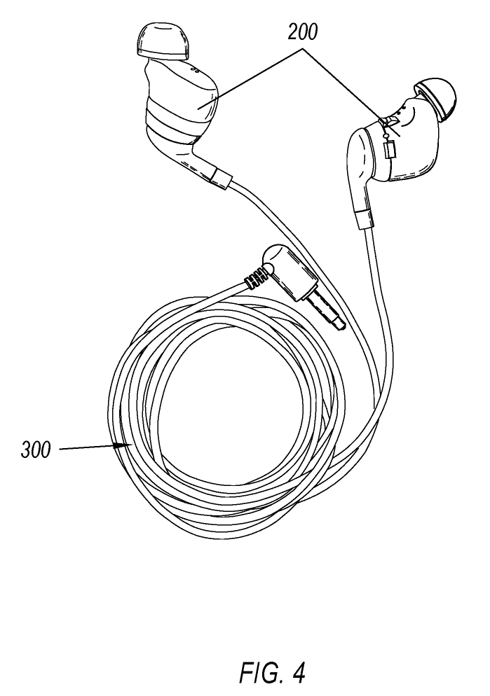

FIG. 4 illustrates an example of earbuds 200 connected to a cable 300. When connected, the cable 300 can provide power to the earbuds 200. Likewise, the cable 300 can provide an audio signal to the earbuds 200. That is, the cable 300 can act as both a data source and a power source simultaneously if so desired.

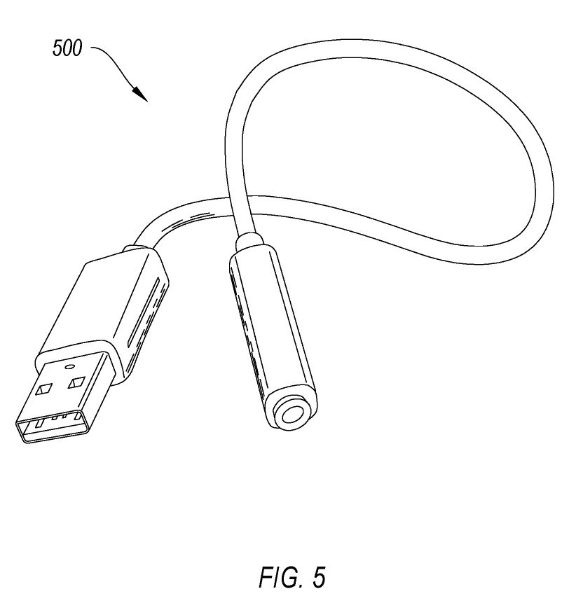

FIG. 5 illustrates an example of a converter 500 for connecting an external device to the earbud via a cable, such as the cable 300 of FIG. 3. The converter 500 can connect the earbud for purposes of transmitting data, for charging the battery, or both. For example, the converter 500 can convert between an audio jack and USB, lightning connectors, mini USB or any other desired connector. The converter 500 can allow only a charging signal but no data signal, only a data signal and no charging signal or allow both.

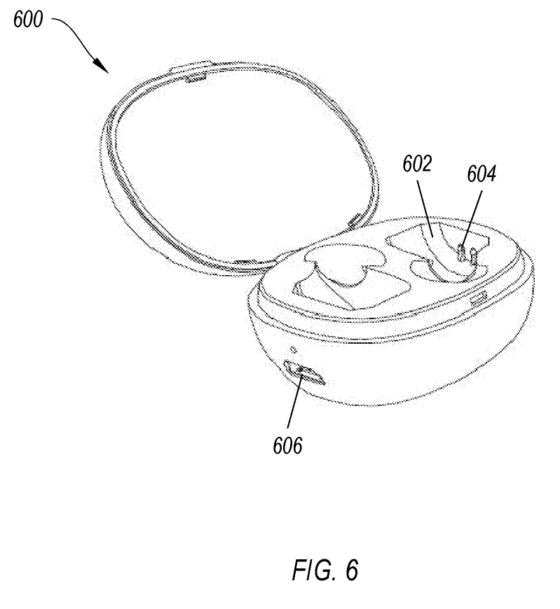

FIG. 6 illustrates an example of a charging case 600. The charging case 600 is used in conjunction with a set of earbuds. I.e., the charging case 600 can receive the earbuds to supply a charge the earbuds. That is, the charging case 600 can receive one or more earbuds and charge the earbuds. Likewise, the charging case 600 can be used to store the earbuds. In particular, since the earbuds are small the charging case 600 allows them to be stored in a way that they are less likely to be misplaced or lost by a user.

FIG. 6 shows that the charging case 600 can include at least one cavity 602. The cavity 602 is configured to receive one or more earbuds. I.e., the cavity 602 is of proper size and shape to receive at least a portion of one or both earbuds. The cavity 602 can cushion or otherwise protect the earbuds. For example, the cavity 602 can be made of a soft material that protects the earbuds, such as foam or rubber.

FIG. 6 also shows that the charging case 600 can include a coupler 604. The coupler 604 connects to the connector of an earbud. The coupler 604 allows one or more signals (including a possible power signal) to pass to the earbud. That is, the coupler 604 includes electrical contacts that match the electrical contacts on an earbud, allowing electrical signals to be passed to the earbud. The electrical contacts of the coupler 604 are separated by one or more insulating sections to prevent shorting of the electrical contacts.

FIG. 6 further shows that the charging case 600 can include an input port 606. The input port 606 allows the case to be charged or to receive a data signal (such as a firewire update) to the earbuds. For example, the input port 606 can receive power to charge a battery in the charging case 600 which is, in turn, used to charge the battery in each earbud.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An earbud for producing a sound output based on an audio signal that is received via a wired connection or wirelessly, the earbud comprising:
a speaker configured to produce a sound based on an audio signal;
a battery, wherein the battery is configured to provide power to the speaker;
an antenna, wherein the antenna is configured to connect wirelessly to an external device;
a connector, the connector configured to:
receive power to charge the battery; and
connect to the external device;
wherein the audio signal is received either over the connector or the antenna;
a processor configured to control the electrical elements of the earbud.

2. The earbud of claim 1, wherein the speaker includes a grill.

3. The earbud of claim 1, wherein the antenna communicates via a Bluetooth protocol.

4. The earbud of claim 1, wherein the antenna communicates via an iEEE 802.11 protocol.

5. The earbud of claim 1, wherein the antenna includes an amplifier that amplifies the received signal.

6. The earbud of claim 1, wherein the audio signal is received:
via the antenna when the connector is disconnected; and
via the connector when the connector is connected.

7. An earbud for producing a sound output based on an audio signal that is received via a wired connection or wirelessly, the earbud comprising:
a speaker, wherein the speaker produces a sound based on an audio signal;
a battery, wherein the battery provides power to the speaker;
a user input, wherein the user input receives one or more commands from a user;
an antenna, wherein the antenna connects wirelessly to an external device;
a connector, the connector:
receiving power to charge the battery; and
connected to the external device;
wherein the audio signal is received either over the connector or the antenna;
a processor, wherein the processor controls at least some of the electrical elements of the earbud.

8. The earbud of claim 7, wherein the user input includes a button.

9. The earbud of claim 7, wherein the user input includes at least one of:
a slide switch;
a dial;
a wheel;
a navigation pad; or
a touch pad.

10. The earbud of claim 7 further comprising a microphone, the microphone receiving sound signals and producing an electrical signal based on the received sound signal.

11. The earbud of claim 10, wherein the microphone includes a preamplifier.

12. The earbud of claim 10, wherein the microphone includes at least one of:
a dynamic transducer;
a condenser transducer; or
a piezoelectric transducer.

13. An earbud for producing a sound output based on an audio signal that is received via a wired connection or wirelessly, the earbud comprising:
an audio cone, the audio cone shaped to fit the ear canal of a user;
a tip covering the audio cone;
a speaker within the audio cone, wherein the speaker produces a sound based on an audio signal;
a battery, wherein the battery provides power to the speaker;
a user input, wherein the user input receives one or more commands from a user;
an antenna, wherein the antenna connects wirelessly to an external device;
a connector, the connector:
receiving power to charge the battery; and
connected to the external device;
wherein the audio signal is received either over the connector or the antenna;
a cable, wherein the cable:
includes a coupler that is electrically connected to the connector; and
is connected to the connector and the external device;
a processor, wherein the processor controls at least some of the electrical elements of the earbud.

14. The earbud of claim 13 further including a charging case.

15. The earbud of claim 13, wherein the cable includes a jack for connecting to the external device.

16. The earbud of claim 15, wherein the jack includes a lightning connector.

17. The earbud of claim 15, wherein the jack includes a USB connection.

18. The earbud of claim 15, wherein the jack includes a 3.5 mm audio jacket.

19. The earbud of claim 13, wherein the coupler includes an aligning feature.

20. The earbud of claim 19, wherein the aligning feature includes at least one of:
a protrusion;
an indentation; or
a magnet.
